(19) United States
(12) Patent Application Publication
(10) Pub. No.: US 2026/0230563 A1
(43) Pub. Date: Aug. 6, 2026

(54) DOCUMENT READING APPARATUS THAT CORRECTS READ IMAGE DATA

(71) Applicant: CANON KABUSHIKI KAISHA, Tokyo (JP)

(72) Inventor: MASANORI HIRONISHI, Tokyo (JP)

(21) Appl. No.: 19/458,404

(22) Filed: Jan. 23, 2026

(30) Foreign Application Priority Data
Feb. 4, 2025 (JP) 2025-016996

(51) Int. Cl. H04N 1/00; H04N 1/387

(52) U.S. Cl. CPC H04N 1/00005; H04N 1/00822; H04N 1/3878

(57) ABSTRACT

Embodiments of a document reading apparatus include an image processing unit configured to generate second image data from first image data by image processing including correction processing of correcting the first image data based on correction data and at least one processor configured to set a reading operation parameter including a resolution parameter, perform generation processing of generating the correction data by causing a reading unit to read a reference member, and control whether to set a resolution in a width direction when causing the reading unit to read the reference member to a first resolution or a second resolution lower than the first resolution based on parameters regarding a size of a document included in the reading operation parameter in a case where a resolution parameter when performing the generation processing indicates the second resolution.

### BACKGROUND

### Field of the Technology

The present disclosure relates to a document reading apparatus that reads an image of a document.

### Description of the Related Art

The document reading apparatus includes a reading unit that optically reads an image of a document. As an example, the reading unit includes a line sensor that reads an image of one line in a main scanning direction. The document reading apparatus reads a document by repeatedly reading, by the reading unit, an image of one line of the document placed on a document glass plate while moving the reading unit in a sub-scanning direction orthogonal to the main scanning direction.

A document reading apparatus including an auto document feeder (ADF) reads a document by repeatedly reading, by a reading unit, an image of one line of the document conveyed in a sub-scanning direction (conveyance direction). Note that the ADF includes a tray on which documents are stacked, and feeds, one by one, the documents stacked on the tray to a conveyance path of the document reading apparatus. In the following description, reading while conveying a document is also referred to as "flow reading". In the document reading apparatus, it may be important to shorten the time from the input of a reading start instruction to the output of image data that is a reading result of a document, that is, first copy output time (FCOT).

In reading a document, the document reading apparatus performs shading correction for correcting a difference in light amount at each position in the main scanning direction and a difference in sensitivity of each pixel of a line sensor. Correction data to be used in shading correction is generated by reading a white reference plate provided in the document reading apparatus. In the following description, the correction data to be used in shading correction is also simply referred to as "correction data", and the processing of generating the correction data is also simply referred to as "generation processing". Japanese Patent Laid-Open No. 2011-023990 discloses that generation processing is executed at a time of power activation.

The document reading apparatus is configured to be able to read a document at various resolutions. Here, the correction data to be used when the document reading apparatus reads a document at a certain resolution needs to be generated by reading a reference plate at that resolution. That is, the correction data is associated with the reading resolution of the document, and, in shading correction at the time of document reading, the document reading apparatus uses correction data of the resolution (correction data associated with the resolution) in the reading.

Therefore, in a case where the resolution associated with the correction data generated at a time of power activation is different from the resolution designated at the time of reading, the correction data generated at the time of power activation cannot be used in the shading correction in the reading. Therefore, it is necessary for the document reading apparatus to perform generation processing of generating correction data with a resolution designated in reading of a document before starting reading of the document, and the FCOT becomes long. Therefore, U.S. Patent No. 10,999,461 discloses a configuration in which generation processing is executed with a change in resolution setting by a user as a trigger.

### SUMMARY

The present disclosure provides techniques for suppressing the FCOT from increasing or appropriately executing generation processing of correction data.

According to an aspect of the present disclosure, a document reading apparatus includes a tray on which a document can be placed; a conveyance unit configured to convey the document placed on the tray; a reading unit configured to read the document being conveyed in a conveyance direction by the conveyance unit to output first image data; an image processing unit configured to generate second image data from the first image data by image processing including correction processing of correcting the first image data based on correction data; a reference member; and at least one processor configured to set a reading operation parameter including a resolution parameter indicating a resolution in the conveyance direction and a resolution in a width direction orthogonal to the conveyance direction of an image indicated by the second image data, perform generation processing of generating the correction data by causing the reading unit to read the reference member, and control whether to set the resolution in the width direction when causing the reading unit to read the reference member to a first resolution or a second resolution lower than the first resolution based on one or more parameters regarding a size of a document included in the reading operation parameter in a case where the resolution parameter when performing the generation processing indicates the second resolution as the resolution in the width direction.

Features of various embodiments of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate example embodiments of the present disclosure, and together with the description, serve to explain the principles of the embodiments.

FIG. 1 is a schematic cross-sectional view of a document reading apparatus.

FIG. 2 is a block diagram illustrating a control configuration of the document reading apparatus.

FIG. 3 is a view illustrating an outer appearance example of an operation unit.

FIGS. 4A and 4B are explanatory views of correction data.

FIG. 5 is an explanatory view of skew detection and correction.

FIGS. 6A to 6D are views illustrating screen examples to be displayed on the operation unit.

FIG. 7 is an explanatory view of a relationship between a resolution in a main scanning direction and a detected skew amount.

FIG. 8 is a flowchart of processing to be executed by a reading control unit.

FIG. 9 is a flowchart of generation processing.

FIG. 10 is a flowchart of determination processing of a main scanning resolution.

FIGS. 11A to 11D are views illustrating a relationship between a reading operation parameter and a main scanning resolution at the time of reading.

FIG. 12 is a more detailed flowchart of the generation processing.

### DESCRIPTION OF THE EMBODIMENTS

Hereinafter, example embodiments will be described in detail with reference to the attached drawings. Note, the following embodiments are not intended to limit the scope of the claims. Multiple features are described in the example embodiments, but it is not the case that all such features are required, and multiple such features may be combined as appropriate. Furthermore, in the attached drawings, the same reference numerals are given to the same or similar configurations, and redundant descriptions thereof are omitted.

### First Embodiment

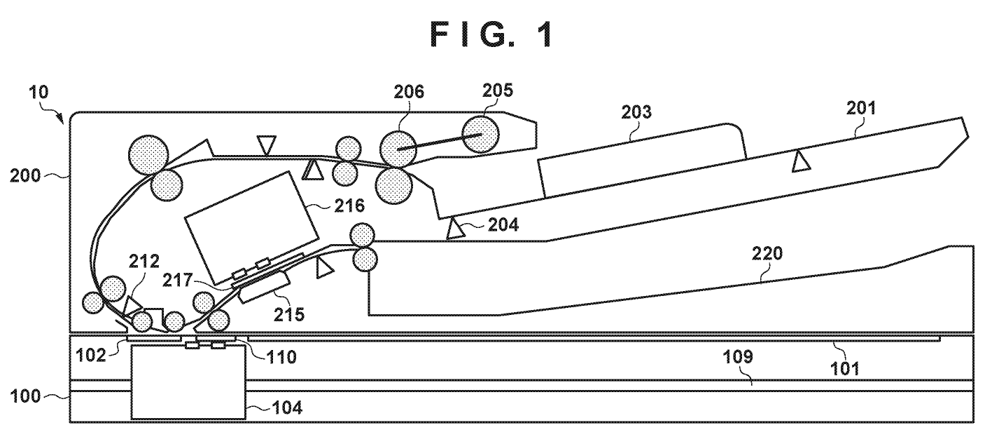

FIG. 1 is a schematic cross-sectional view of a document reading apparatus 10 according to the present embodiment. The document reading apparatus 10 includes a reader 100 that generates image data by reading a document and includes an ADF 200 that feeds the document to the reader 100. The document reading apparatus 10 can transmit the generated image data to a personal computer (PC) via a network. A document of a reading target is placed on a document tray 201. A detection sensor 204 detects whether or not a document is placed on the document tray 201. A guide plate 203 regulates a position in a width direction of the document placed on the document tray 201. Note that the width direction is a direction orthogonal to a conveyance direction of the document and corresponds to a main scanning direction. The conveyance direction corresponds to a sub-scanning direction.

A pickup roller 205 feeds an uppermost document of one or more documents placed on the document tray 201 to a conveyance path of the document reading apparatus 10. A separation roller pair 206 is provided to prevent double feeding of documents. The document reading apparatus 10 includes a plurality of rollers for conveying a document along the conveyance path. The conveyance path and the plurality of rollers function as a conveyance unit that conveys the document. A reading unit 104 optically reads, via a glass 102, a first surface of the document being conveyed on the conveyance path. A reading unit 216 optically reads, via a glass 217, a second surface of the document being conveyed on the conveyance path. The reading unit 104 and the reading unit 216 each include a light source, such as a light emitting diode (LED), that can emit light of red (R), green (G), and blue (B). Each of the reading unit 104 and the reading unit 216 includes a line sensor that receives light emitted from the light source and reflected by the document. The line sensor includes a plurality of light receiving elements (pixels) provided along the main scanning direction.

The document whose second surface has been read by the reading unit 216 is discharged to a discharge tray 220. A leading sensor 212 detects a document to be conveyed. The detection timing of the document by the leading sensor 212 is used to determine the reading timing of the document by the reading unit 104 and the reading unit 216. A reference plate 110 of white color is a reference member to be used to generate correction data to be used in shading correction at the time of reading by the reading unit 104. A reference plate 215 of white color is a reference member to be used to generate correction data to be used in shading correction at the time of reading by the reading unit 216.

The reading unit 104 is configured to be movable in a left-right direction of the drawing along a moving guide 109 in order to read the document placed on a document glass plate 101. A position at which the reading unit 104 reads the document being conveyed and a position at which the reading unit 104 reads the reference plate 110 can be different. In a case where the position at which the reading unit 104 reads the document being conveyed and the position at which the reading unit 104 reads the reference plate 110 are different, the reading unit 104 is moved to the position at which the reading unit 104 reads the reference plate 110 when the reading unit 104 reads the reference plate 110.

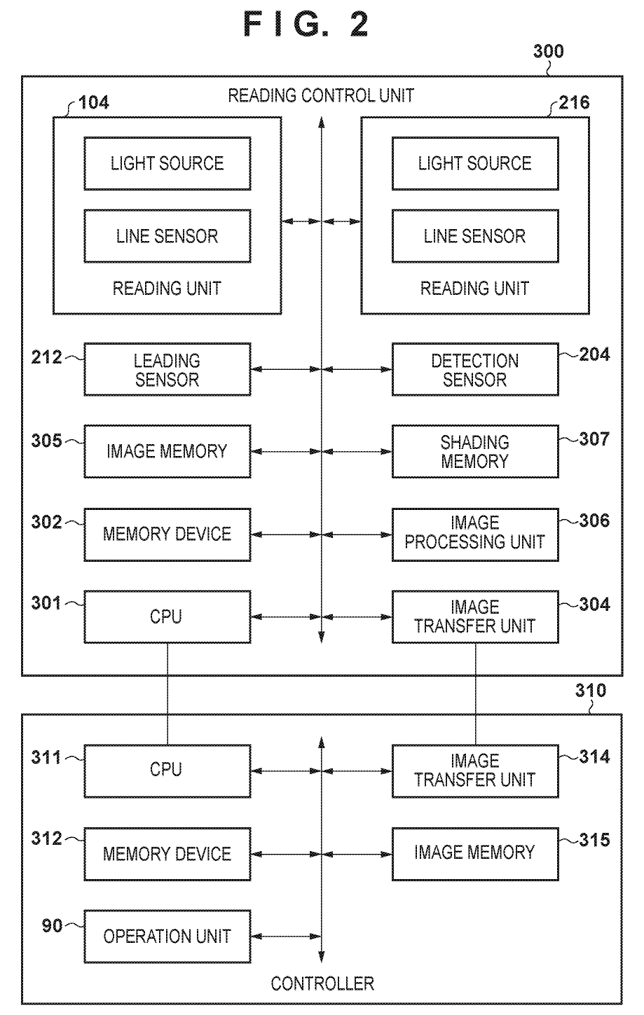

FIG. 2 is a block diagram illustrating a control configuration of the document reading apparatus 10. A controller 310 controls the entire document reading apparatus 10. A reading control unit 300 controls the ADF 200 and the reader 100 under the control of the controller 310.

A CPU 301 of the reading control unit 300 controls the ADF 200 and the reader 100 by executing a program stored in a memory device 302. The memory device 302 includes a volatile memory device and a nonvolatile memory device. The memory device 302 stores a program to be executed by the CPU 301 and various types of information used for control of the ADF 200 and the reader 100. An image memory 305 is used to temporarily store image data (hereinafter, referred to as read image data) of images (hereinafter, referred to as read images) read by the reading unit 104 and the reading unit 216. ‎ ‎ An image processing unit 306 performs various types of image processing including shading correction processing on the image data of the read images stored in the image memory 305 to generate image data (hereinafter, referred to as document image data) of images of the document (hereinafter, referred to as document images). ‎ ‎ Note that the image processing unit 306 performs shading correction using correction data stored in a shading memory 307. An image transfer unit 304 transmits document image data generated by image processing by the image processing unit 306 to an image transfer unit 314 of the controller 310.

A CPU 311 of the controller 310 controls the entire document reading apparatus 10 by executing a program stored in a memory device 312. The CPU 311 transmits and receives various control commands and control data to and from the CPU 301 in order to control the reading control unit 300. The memory device 312 includes a volatile memory device and a nonvolatile memory device. The memory device 312 stores a program to be executed by the CPU 311 and various types of information used for control of the document reading apparatus 10.

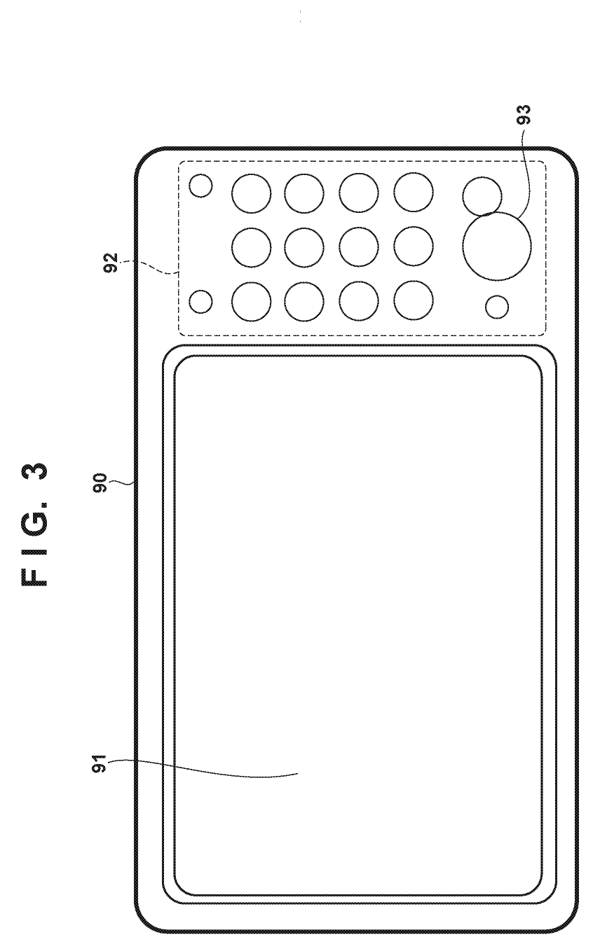

The image transfer unit 314 stores, into an image memory 315, the document image data received from the image transfer unit 304. Note that this document image data is transmitted to, for example, an external PC or the like by the CPU 311. An operation unit 90 provides a user interface for a user to operate the document reading apparatus 10. FIG. 3 illustrates an example of an outer appearance of the operation unit 90. An operation key group 92 including a reading start key 93 is used by the user to perform various types of inputting to the document reading apparatus 10. Note that the reading start key 93 is a key for instructing reading start of a document. A touch panel display 91 displays a state of the document reading apparatus 10 to the user. Note that the user can also perform various types of inputting via the touch panel display 91. Although not illustrated, the document reading apparatus 10 can also be configured to be operated by an operation command or the like received from an external PC via a network.

For example, when the user inputs an instruction for reading start of a document using the reading start key 93, the CPU 311 transmits a reading start request to the CPU 301. The CPU 301 performs document reading control in response to the reading start request from the CPU 311. The CPU 301 notifies the CPU 311 of a progress status of the document reading control and the like, and the CPU 311 displays, on the operation unit 90, the progress status and the like.

By causing the reading unit 104 to read the reference plate 110, the CPU 301 generates correction data to be used in shading correction on read image data read by the reading unit 104, that is, correction data for the reading unit 104. By causing the reading unit 216 to read the reference plate 215, the CPU 301 generates correction data to be used in shading correction on read image data read by the reading unit 216, that is, correction data for the reading unit 216. Note that a generation method of correction data for the reading unit 104 and a generation method of correction data for the reading unit 216 are similar, and therefore the generation method of correction data for the reading unit 104 will be described below as an example, and description regarding the reading unit 216 will be omitted.

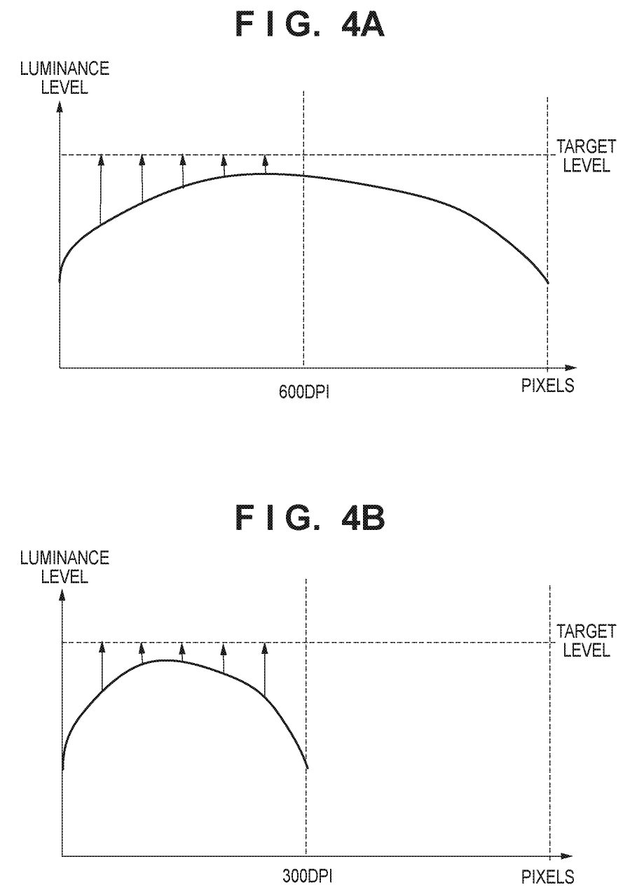

FIG. 4A illustrates a reading result when the reference plate 110 is read with the resolution in the main scanning direction set to 600 DPI, more specifically, luminance levels detected by pixels arrayed along the main scanning direction of the line sensor. The luminance levels detected by the pixels of the line sensor when the reference plate 110 is read are ideally the same, but actually, the luminance levels are not the same due to a difference in irradiation light amount at a position in the main scanning direction or a difference in sensitivity of the pixels of the line sensor. The correction data is data indicating a correction coefficient of each pixel for setting, to a target level, the luminance level detected by each pixel of the line sensor when the reference plate 110 is read. In FIG. 4A, each arrow corresponds to a correction coefficient. The correction data includes data for the number of pixels in the main scanning direction for each color of light emitted by the light source.

FIG. 4B illustrates a reading result when the reference plate 110 is read with the resolution in the main scanning direction set to 300 DPI. The number of pixels in the main scanning direction is 1/2 of the number of pixels when read at 600 DPI. As illustrated in FIGS. 4A and 4B, since the relationship between each pixel and the correction coefficient varies depending on the resolution in the main scanning direction, the correction data needs to be generated for each resolution in the main scanning direction. Note that in a case of reading in monochrome, light of red (R), green (G), and blue (B) is emitted at the same timing, but in a case of document reading in color, light of red (R), green (G), and blue (B) is emitted with different timings. Therefore, correction data to be used in reading in color and correction data to be used in reading in monochrome are different.

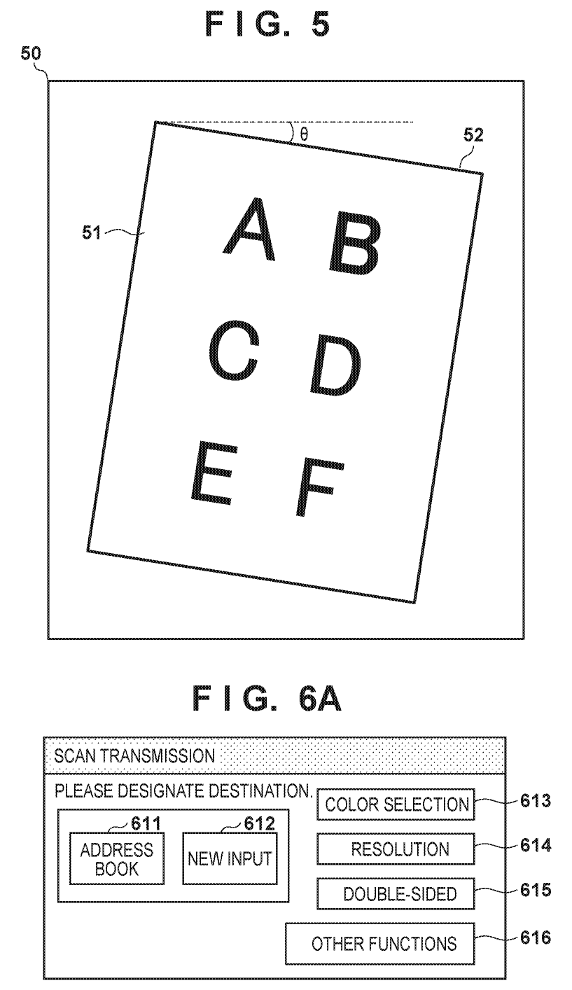

Next, detection of skew of a document and skew correction will be described. In consideration of skew of the document, the reading unit 104 and the reading unit 216 set the reading timing of the document and the length in the main scanning direction to be read so that the entire document can be read even if skew occurs. FIG. 5 illustrates an example of a read image 50 read by the reading unit 104 when a document 51 with skew is read. In the read image 50, a shadow by a side 52 on a leading end side occurs on the leading end side in the conveyance direction of the document 51. The image processing unit 306 detects this shadow based on the read image data indicating the read image to detect an angle θ of the side 52 with respect to the width direction, that is, the skew amount. The image processing unit 306 performs skew correction by performing image rotation processing such that the direction of the side 52 coincides with the width direction. Note that the image processing unit 306 can further perform shift correction so that the position of the leading end left side corner of the document 51 becomes a predetermined position.

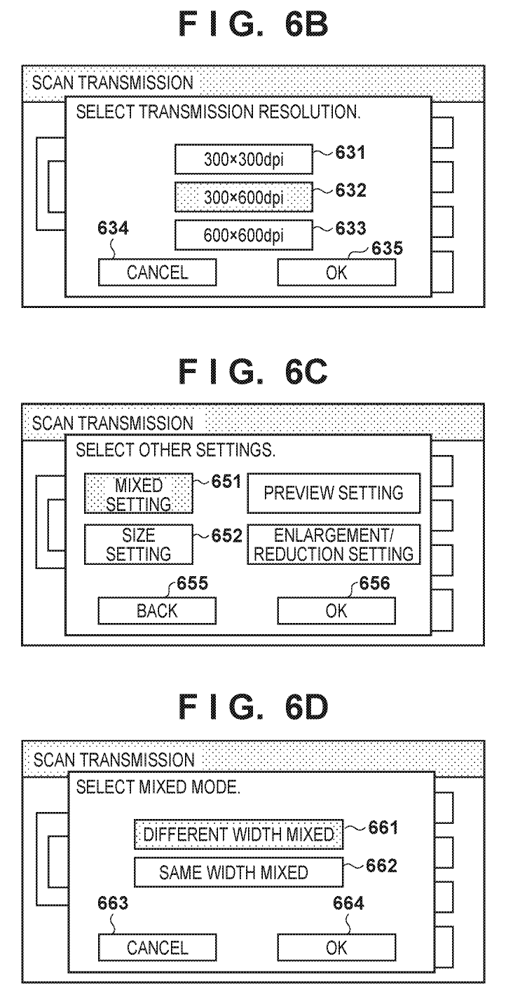

FIGS. 6A to 6D illustrate screen examples to be displayed on the operation unit 90. FIG. 6A is a top screen to be displayed after activation of the document reading apparatus 10, for example. When an address book button 611 is pressed, the CPU 311 displays, on the operation unit 90, a screen for selecting a PC of a transmission destination of the document image data. When a new input button 612 is pressed, the CPU 311 displays, on the operation unit 90, a screen for registering a PC as a transmission destination of the document image data. When a color selection button 613 is pressed, the CPU 311 displays, on the operation unit 90, a screen for designating whether to read the document in color or read the document in monochrome. When a double-sided button 615 is pressed, the CPU 311 displays, on the operation unit 90, a screen for designating whether to read only one side of the document or read both sides of the document. When a button 616 is pressed, the CPU 311 displays, on the operation unit 90, another setting screen. When a resolution button 614 is pressed, the CPU 311 displays, on the operation unit 90, a screen for designating the resolution of a document image.

FIG. 6B illustrates a screen example to be displayed on the operation unit 90 by pressing the resolution button 614. A button 631, a button 632, and a button 633 are buttons for setting the resolution of a document image to 300 × 300 DPI, 300 × 600 DPI, and 600 × 600 DPI, respectively. Note that the part before " × " indicates the resolution in the main scanning direction, and the part after " × " indicates the resolution in the sub-scanning direction. In the following description, the resolution in the main scanning direction is also referred to as "main scanning resolution", and the resolution in the sub-scanning direction is also referred to as "sub-scanning resolution". In FIG. 6B, only three resolution patterns are illustrated as options, but selectable resolution patterns may be two or four or more.

The hatching in FIG. 6B indicates a currently selected resolution. When an OK button 635 is pressed, the CPU 311 updates the resolution setting to the resolution selected on the screen of FIG. 6B, and displays, on the operation unit 90, the screen of FIG. 6A. When a cancel button 634 is pressed, the CPU 311 displays, on the operation unit 90, the screen of FIG. 6A without updating the resolution setting, that is, while maintaining the current setting.

FIG. 6C illustrates a screen example to be displayed on the operation unit 90 by pressing on the button 616 of FIG. 6A. When a button 655 is pressed, the CPU 311 displays, on the operation unit 90, the screen of FIG. 6A. When an OK button 656 is pressed in a state where a size setting button 652 is selected, the CPU 311 displays, on the operation unit 90, a screen for designating the size of the document. On this screen, for example, the user can set the size of the document to a standard size, such as A4 or B4, as well as "nonstandard size", which is not a standard size. When the OK button 656 is pressed in a state where a mixed setting button 651 is selected, the CPU 311 displays, on the operation unit 90, the screen illustrated in FIG. 6D.

In the screen of FIG. 6D, the user can select and set a different width mixed mode and a same width mixed mode. The different width mixed mode is a mode in which a plurality of documents having different widths are stacked on the document tray 201, and these documents are sequentially conveyed to perform document reading. The same width mixed mode is a mode in which only documents having the same width are stacked on the document tray 201, and these documents are sequentially conveyed to perform document reading. Note that in the different width mixed mode and the same width mixed mode, the lengths in the conveyance direction of the documents stacked on the document tray 201 may be different. When an OK button 664 is pressed in a state where a button 661 is selected, the CPU 311 sets the different width mixed mode. When the OK button 664 is pressed in a state where a button 662 is selected, the CPU 311 sets the same width mixed mode. When the cancel button 634 is pressed, the CPU 311 displays, on the operation unit 90, the screen of FIG. 6C without updating the setting of the mixed mode, that is, while maintaining the current setting.

In this manner, the CPU 311 functions as a setting unit that sets various parameters (hereinafter, referred to as reading operation parameters) in the reading operation based on a user input. ‎ The reading operation parameter includes a resolution parameter indicating the main scanning resolution and the sub-scanning resolution of a document image. The reading operation parameter includes a mixed parameter indicating whether to perform the different width mixed mode or the same width mixed mode. The reading operation parameter includes a size parameter indicating whether or not to perform reading of a document of a standard size. The reading operation parameter includes a color parameter indicating whether to perform reading in color or reading in monochrome. The reading operation parameter includes a surface parameter indicating whether to perform reading of only one side or reading of both sides.

As described above, in the different width mixed mode, a plurality of documents having different widths are stacked on the document tray 201. Therefore, the guide plate 203 regulates only the document having the largest width, and the other documents are not regulated by the guide plate 203. Therefore, skew is more likely to occur in the different width mixed mode than in the same width mixed mode. In general, in order to make it easy to regulate a document having a standard size, a groove is provided at a position having a width of the standard size on a rail on which the guide plate 203 is moved in the width direction. Therefore, the document having a nonstandard size different from a standard size is more likely to skew than the document having a standard size.

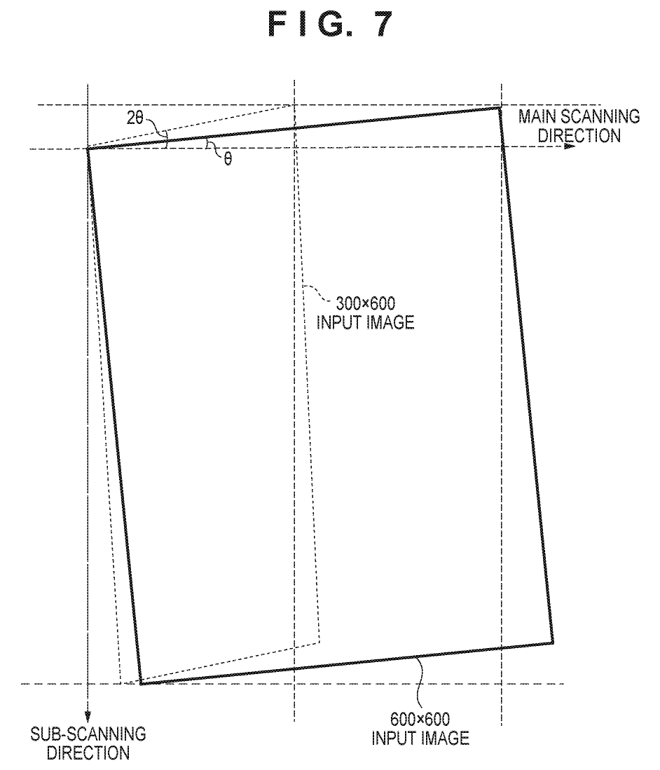

FIG. 7 is an explanatory view of the relationship between a resolution and a skew angle detected by skew correction. Assuming that the main scanning resolution is 300 DPI, the number of pixels in the main scanning direction is 1/2 of the number of pixels in a case of 600 DPI. Therefore, in a case where the skew angle detected at 600 DPI is θ, the skew angle is detected as 2θ at 300 DPI. Since there is an upper limit to the correctable skew amount, when the angle is detected as double, the range of the actually correctable angle is 1/2. For example, in a case where the upper limit of the correctable angle is 5 degrees, when the main scanning resolution is set to 300 DPI, 6 degrees, which exceeds the upper limit of the correctable angle, is detected even if the actual skew angle is 3 degrees. Therefore, in a case where the different width mixed mode in which skew is likely to occur is set, or in a case where the document is a nonstandard size, it is preferable to perform reading at a high resolution at least in the main scanning direction in order to increase the correctable angle range as much as possible.

In a case where the resolution of reading is increased, it is necessary to lower the conveyance speed lower than in a case where the resolution of reading is decreased. This is based on the fact that the higher the resolution is, the larger the data amount of the read image data is, and the longer the time required for the reading units 104 and 216 to output the read image data is. Therefore, performing reading at a high resolution can make skew less likely to occur due to a low conveyance speed.

Therefore, in a case where the different width mixed mode is set, or in a case where the document is a nonstandard size, the CPU 301 causes the document reading to be performed with the main scanning resolution set to 600 DPI even if the main scanning resolution of the document image is set to 300 DPI. In a case of causing the document reading to be performed with the main scanning resolution set to 600 DPI, the CPU 301 can lower the conveyance speed of the document lower than in a case of causing the document reading to be performed with the main scanning resolution set to 300 DPI. Note that at this time, the CPU 301 may either keep the sub-scanning resolution as set for the document image or change it to a resolution higher than the setting of the document image. That is, in a case where both the main scanning resolution and the sub-scanning resolution of the document image are 300 DPI, both the main scanning resolution and the sub-scanning resolution may be 600 DPI or only the main scanning resolution may be 600 DPI in reading the document.

In a case where the document is read with the main scanning resolution set to 600 DPI when the main scanning resolution of the document image is set to 300 DPI, the image processing unit 306 performs resolution conversion processing such that the main scanning resolution and the sub-scanning resolution of the document image are as set after skew correction and shading correction.

Note that even in a case where the different width mixed mode is set, or in a case where the document is a nonstandard size, in a case where the main scanning resolution of the document image is 600 DPI, the CPU 301 reads the document in accordance with the main scanning resolution and the sub-scanning resolution of the document image. Then, the image processing unit 306 transmits, to the controller 310, document image data generated by image processing, such as skew correction and shading correction, without performing resolution conversion processing.

When the user presses the reading start key 93 of the operation unit 90, the CPU 311 transmits a document reading start request to the CPU 301. The reading start request includes the above-described reading operation parameter. The reading start request also indicates whether or not to be flow reading. In the following description, it is assumed that the reading start request is a reading start request for flow reading.

The CPU 311 is configured to notify the CPU 301 of a reading operation parameter after a change in a case where the user operates the operation unit 90 to make an input for changing the setting of the reading operation parameter. Note that the CPU 311 is configured to notify the CPU 301 of a default reading operation parameter at the time of activation of the document reading apparatus 10. The change of a reading operation parameter is determined when the user selects one of the setting options and presses an OK button. For example, in the screen of FIG. 6B, it is determined whether or not the setting of the resolution parameter has been changed when the user selects one of the resolution options and presses the OK button 635. When the user selects a resolution different from the current setting and presses the OK button 635, the CPU 311 determines that the reading operation parameter has been changed. On the other hand, when the user selects the same resolution as the currently set resolution and presses the OK button 635, the CPU 311 can determine that the reading operation parameter has not been changed. The same applies to the mixed mode and the document size. Note that the CPU 311 can be configured to notify the CPU 301 of part of the content of a reading operation parameter, for example, only the changed parameter in a case where the content of the reading operation parameter has been changed.

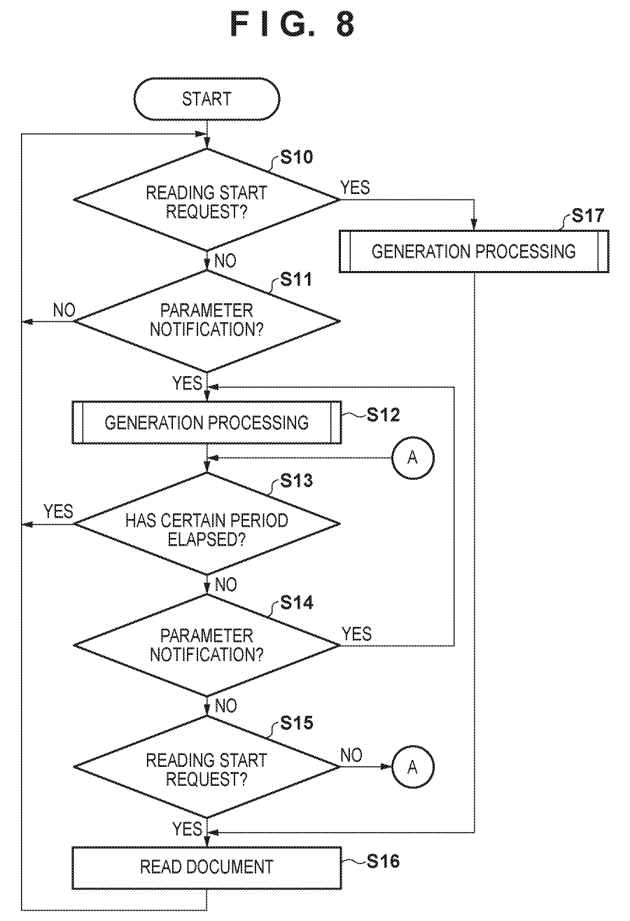

FIG. 8 is a flowchart of processing to be executed by the reading control unit 300. Note that it is assumed that correction data has not been generated at the time point of start of the processing of FIG. 8. In S10, the CPU 301 determines whether a reading start request has been received from the CPU 311. In a case where the reading start request has been received in S10, the CPU 301 performs in S17 generation processing of correction data based on the reading operation parameter received together with the reading start request. The content of the generation processing will be described later. Then, in S16, the CPU 301 performs document reading. Note that the conveyance speed of the document is controlled based on the resolution of document reading. In S16, the image processing unit 306 performs shading correction using the correction data generated in S17. The image processing unit 306 performs skew correction processing and resolution conversion processing as necessary. Note that in a case where the reading start request is received when no document is placed on the document tray 201, the CPU 301 can be configured to notify the CPU 311 that no document is placed to handle the determination in S10 as "No". After reading the document in S16, the CPU 301 repeats the processing from S10.

In a case where the reading start request has not been received in S10, the CPU 301 determines in S11 whether the reading operation parameter has been notified from the CPU 311. In a case where the reading operation parameter has not been notified, the CPU 301 repeats the processing from S10. In a case where the reading operation parameter is notified from the CPU 311, the CPU 301 starts generation processing of correction data in S12. Note that the generation processing of the correction data can be configured to be started in S12 only in a case where the document is placed on the document tray 201, and the determination in S11 can be configured to be treated as "No" in a case where the document is not placed on the document tray 201.

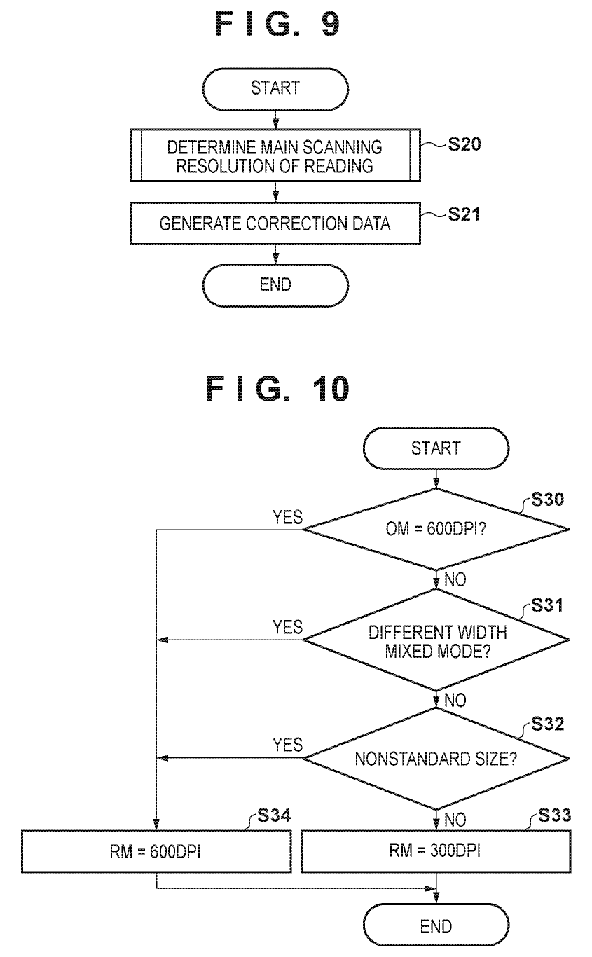

FIG. 9 is a flowchart of generation processing of correction data in S12 and S17. In S20, the CPU 301 determines the main scanning resolution at the time of reading the reference plate 110 based on the main scanning resolution of the document image indicated by the resolution parameter, the setting of the mixed mode indicated by the mixed parameter, and the setting of the document size indicated by the size parameter. In S21, the CPU 301 generates correction data by reading the reference plate 110. Note that at that time, the main scanning resolution is the resolution determined in S20. The correction data is stored in the shading memory 307.

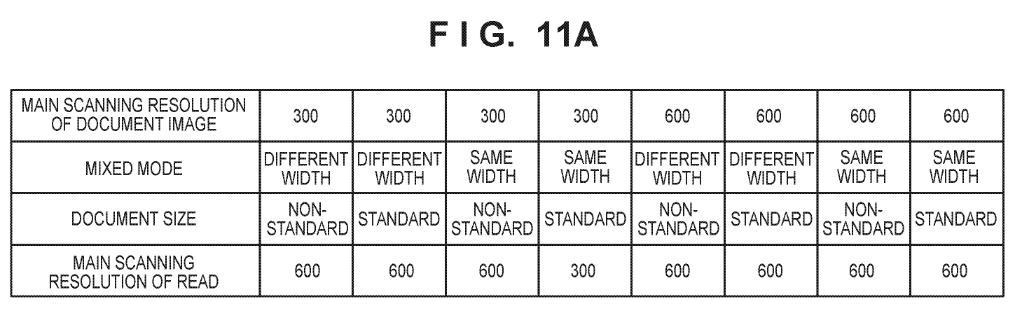

FIG. 10 is a flowchart of the determination processing in S20 of FIG. 9. In S30, the CPU 301 determines whether a main scanning resolution OM of the document image is 600 DPI. In a case where the main scanning resolution OM of the document image is 600 DPI, the CPU 301 sets in S34 a main scanning resolution RM of reading to 600 DPI. In a case where the main scanning resolution OM of the document image is 300 DPI, the CPU 301 determines in S31 whether the different width mixed mode has been set. In a case where the different width mixed mode is set, the CPU 301 sets the main scanning resolution RM of reading to 600 DPI in S34. In a case where the different width mixed mode is not set, the CPU 301 determines in S32 whether the document is a nonstandard size. In a case where the document is a nonstandard size, the CPU 301 sets the main scanning resolution RM of reading to 600 DPI in S34. In a case where the document is not a nonstandard size, that is, in a case where the document is a standard size, the CPU 301 sets the main scanning resolution RM of reading to 300 DPI in S33.

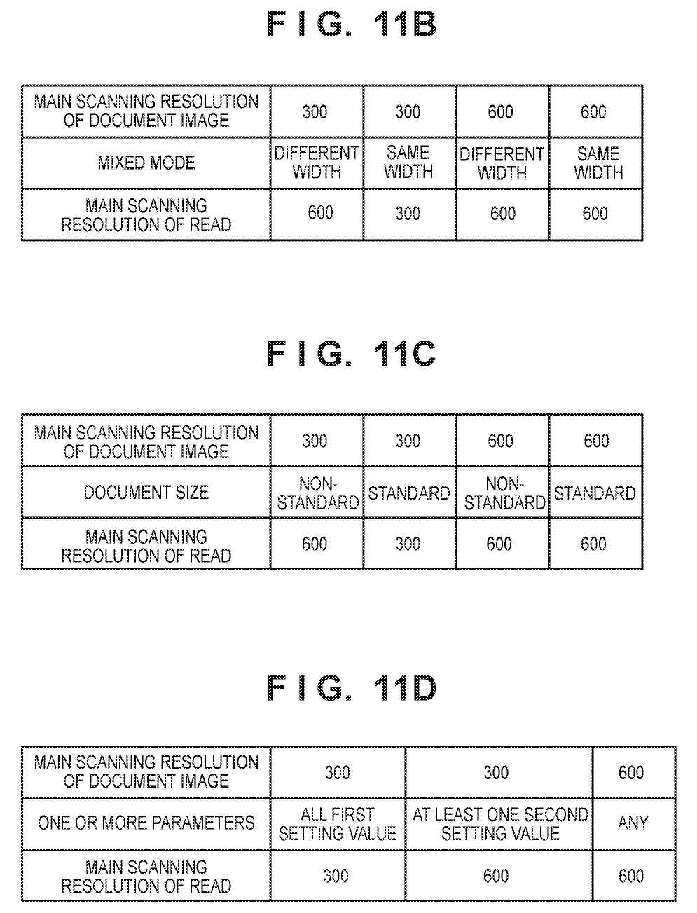

FIG. 11A illustrates a relationship between the combination of the settings of the main scanning resolution of the document image, the mixed mode and the document size, and the main scanning resolution at the time of reading to be determined.

Returning to FIG. 8, upon generating correction data in S12, the CPU 301 transitions to a state of waiting for reception of a reading start request. In S13, the CPU determines whether a certain period has elapsed since the transition to the state of waiting for reception. In a case where the certain period has elapsed, the CPU 301 discards the correction data generated in S12 to repeat the processing from S10. In a case where the certain period has not elapsed in S13, the CPU 301 determines in S14 whether the reading operation parameter has been received from the CPU 311. In a case where the reading operation parameter is received from the CPU 311 in S14, the CPU 301 repeats the processing from S12. In a case where the reading operation parameter has not been received from the CPU 311, the CPU 301 determines whether a reading start request has been received from the CPU 311 in S15. In a case where the reading start request has not been received in S15, the CPU 301 repeats the processing from S13.

In a case where the reading start request has been received in S15, the CPU 301 performs document reading in S16. At this time, the CPU 301 determines the main scanning resolution in reading of the document based on the reading operation parameter included in the reading start request, and the CPU 301 causes the reading unit 104 and the reading unit 216 to read the document with the determined main scanning resolution. The determination processing of main scanning resolution for reading is the same as that in FIG. 10. Note that in a case where the main scanning resolution of reading is 600 DPI when the main scanning resolution of the document image is 300 DPI, the sub-scanning resolution to be used for reading the document may be the sub-scanning resolution of the document image or a resolution higher than the sub-scanning resolution of the document image.

In S16, the image processing unit 306 performs image processing on the read image data. The image processing includes shading correction performed using the correction data stored in the shading memory 307. In a case where skew of the document is detected from the read image data, the image processing includes skew correction. Furthermore, in a case where the document is read with a resolution different from the resolution of the document image indicated by the resolution parameter, the image processing includes resolution conversion processing for setting the resolution of the read image to the resolution indicated by the resolution parameter. After reading the document in S16, the CPU 301 repeats the processing from S10.

Note that in a case where the generation condition of the correction data to be newly generated in S12 is the same as the generation condition of the correction data stored in the shading memory 307, the correction data stored in the shading memory 307 can be configured to be maintained without generating new correction data. That is, in a case where the generation condition of the correction data based on the reading operation parameter after the change is the same as the generation condition of the correction data based on the reading operation parameter before the change, the determination in S14 can be configured to be treated as "No".

The generation condition of correction data is specified by a combination of the main scanning resolution at the time of reading the reference plate and whether or not to read in monochrome. For example, as clear from the table of FIG. 11A, in a case where the different width mixed mode is selected as a mixed mode, the main scanning resolution at the time of reading the reference plate is not changed even if only the main scanning resolution of the document image is changed. In such a case, the CPU 301 can handle the determination in S14 as "No". Note that when the color parameter is changed, the generation condition of the correction data is changed. Therefore, assuming that there is no change in the color parameter, new correction data can be configured to be generated in S12 only in a case where the "main scanning resolution of reading" in FIG. 11A is changed. Note that "main scanning resolution of reading" in FIG. 11A can be the same regardless of the setting of the color parameter.

In the sequence of FIG. 8, in a case where the reading start request is not received even after a certain period of time elapses after the generation processing in S12, the CPU 301 discards the correction data to repeat the processing from S10. However, the correction data generated in the generation processing can be configured to be maintained as long as the generation condition of the correction data is not changed by the change in the reading operation parameter.

In the present embodiment, the main scanning resolution of reading is determined based on the resolution parameter, the mixed parameter, and the size parameter. However, the main scanning resolution of reading can be configured to be determined based only on the resolution parameter and the mixed parameter. FIG. 11B illustrates the main scanning resolution at the time of reading in this case. The main scanning resolution of reading can be configured to be determined based only on the resolution parameter and the size parameter. FIG. 11C illustrates the main scanning resolution at the time of reading in this case.

Note that in the above description, a mixed parameter and a size parameter are exemplified as parameters for determining whether or not skew of the document is likely to occur. However, the parameter for determining whether or not skew of the document is likely to occur is determined based on the content of each parameter settable in the document reading apparatus 10, and is not limited only to the mixed parameter and the size parameter. For example, one or more parameters regarding the size of the document can be used as parameters for determining whether or not skew of the document is likely to occur.

Therefore, more generally speaking, the CPU 301 can determine the main scanning resolution of reading based on the main scanning resolution indicated by the resolution parameter and one or more parameters associated with the likeliness of occurrence of skew of the document. Each of the one or more parameters can be set to a plurality of setting values including a first setting value and a second setting value. Here, skew of the document is more likely to occur in a case where the parameter is set to the second setting value than in a case where the parameter is set to the first setting value.

For example, the setting of the mixed parameter to the same width mixed mode corresponds to the setting of the mixed parameter to the first setting value, and the setting of the mixed parameter to the different width mixed mode corresponds to the setting of the mixed parameter to the second setting value. The setting of the size parameter to any standard size corresponds to the setting of the size parameter to the first setting value, and the setting of the size parameter to a nonstandard size corresponds to the setting of the size parameter to the second setting value.

FIG. 11D illustrates the relationship between the setting values of the main scanning resolution of the document image and one or more parameters, and the main scanning resolution at the time of reading to be determined.

As described above, at the time of reading a document in which skew is likely to occur, even in a case where the set resolution is low, the document is read with a higher resolution, skew correction of the image read by image processing is performed, and then the resolution is converted to the set resolution to output.

In such a case, the set resolution is different from the resolution actually used for document reading. Therefore, as disclosed in U.S. Patent No. 10999461, even if correction data of the resolution after change is generated when the resolution setting is changed, there can be a case where the correction data cannot be used in shading correction at the time of subsequent document reading. In such a case, the document reading apparatus needs to perform generation processing of generating correction data of the resolution used for document reading before document reading, and the FCOT becomes long.

On the other hand, in the present embodiment, in pre-generation processing performed before an instruction for reading start is input, the main scanning resolution at the time of reading the reference plate is set based on the main scanning resolution of the document image and one or more parameters included in the reading operation parameter. This configuration can perform shading correction with the pre-generated correction data when the instruction for reading start is input, and therefore can shorten the FCOT.

The one or more parameters can be parameters regarding the likeliness of occurrence of skew. As an example, the one or more parameters can include a mixed parameter indicating whether or not a plurality of documents having different lengths in the width direction are placed on the document tray 201. In place of or in addition to the mixed parameter, the one or more parameters can include a size parameter indicating whether or not the size of the document is a nonstandard size.

Even if the reading operation parameter is changed, the CPU 301 does not execute the generation processing in a case where the generation condition of correction data to be determined based on the reading operation parameter after change is not changed from the generation condition of the correction data stored in the shading memory 307. For example, the CPU 301 determines whether the main scanning resolution at the time of reading the reference plate is changed by the change of the main scanning resolution of the document image or the setting value of the one or more parameters. Then, the generation processing is executed only in a case where the main scanning resolution is to be changed. This configuration can suppress execution of unnecessary generation processing and can appropriately execute the generation processing of correction data.

### Second Embodiment

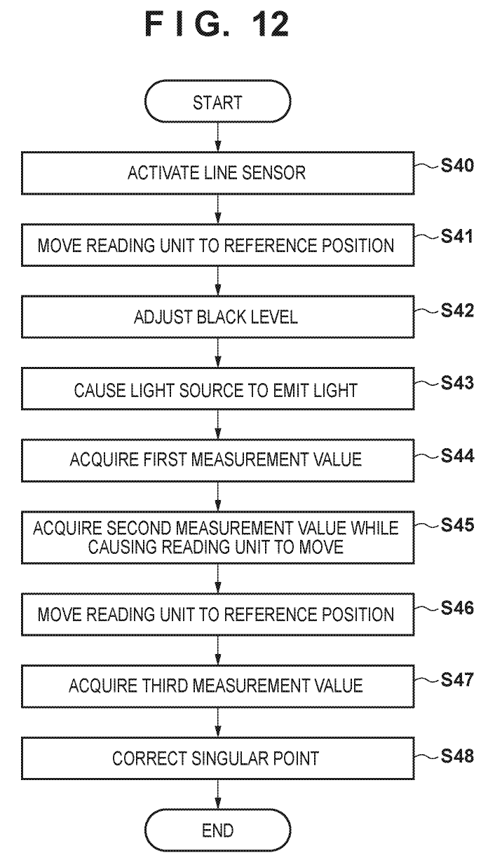

Next, a second embodiment will be described focusing on differences from the first embodiment. FIG. 12 illustrates details of the processing in S21 of FIG. 9.

First, in S40, the CPU 301 activates the line sensor of the reading unit 104, that is, sets it to be operable. In S41, the CPU 301 moves the reading unit 104 to a reference position for reading the reference plate 110. In S42, the CPU 301 executes black level adjustment by performing measurement with the line sensor without causing the light source to emit light. In S43, the CPU 301 causes the light source of the reading unit 104 to emit light. In S44, the CPU 301 acquires a measurement value of the first time (first measurement value) by measuring the reference plate 110. The CPU 301 determines a threshold for extracting a singular point indicating contamination of the reference plate 110 based on the first measurement value. In S45, the CPU 301 measures a measurement value of the second time (second measurement value) by measuring the reference plate 110 while moving the reading unit 104 within a range in which the reference plate 110 can be measured. The CPU 301 extracts a singular point based on the second measurement value to determine a correction coefficient. In S46, the CPU 301 moves the reading unit 104 to the reference position again. In S47, the CPU 301 obtains a measurement value of the third time (third measurement value) by measuring the reference plate 110 at the reference position. The third measurement value is used to generate correction data. In S48, the CPU 301 generates the correction data by performing singular point correction using the correction coefficient determined based on the second measurement value.

For example, in S12 of FIG. 8, in a case where a new reading operation mode is notified during execution of the generation processing, and the generation condition of the correction data based on the new reading operation mode is different from the generation condition of the correction data in the generation processing being executed, it is not necessary to complete the generation processing being executed. Therefore, the CPU 301 stops the generation processing being executed, in a case where the generation condition of the correction data based on the new reading operation mode notified during the execution of the generation processing is different from the generation condition of the correction data in the generation processing being executed. Then, the CPU 301 starts generation processing based on the generation condition of correction data based on the new reading operation mode. Note that in a case where the generation condition of the correction data based on the new reading operation mode is the same as the generation condition of the correction data in the generation processing being executed, the CPU 301 completes the generation processing being executed to generate the correction data. In this case, it is not necessary to perform generation processing based on the new reading operation mode.

Note that as described in the first embodiment, when the color parameter is changed, the generation condition of the correction data is changed. In a case where the color parameter has not been changed, the change of "main scanning resolution of reading" in the tables of FIGS. 11A to 11D corresponds to the change of the generation condition of correction data.

As described above, the FCOT can be shortened by stopping unnecessary generation processing.

### Other Embodiments

Note that in each of the above embodiments, 300 DPI and 600 DPI are used as examples of the main scanning resolution of the document image, but the settable main scanning resolutions are not limited to 300 DPI and 600 DPI.

In each of the above embodiments, two main scanning resolutions of 300 DPI and 600 DPI are exemplified as the main scanning resolution of the document image. However, each of the above embodiments is applicable even in a case where three or more resolutions can be set as a main scanning resolution. For example, it is assumed that the first resolution to the third resolution can be set as a main scanning resolution. Note that it is assumed that the first resolution is the lowest resolution and the third resolution is the highest resolution. In this case, if skew of the document is likely to occur, and the main scanning resolution of the document image is the first resolution or the second resolution, the main scanning resolution of reading can be configured to be set to the third resolution. Also, if skew of the document is likely to occur, and the main scanning resolution of the document image is the first resolution, the main scanning resolution of reading can be set to the second resolution. In a case where the main scanning resolution of the document image is the second resolution or the third resolution, the main scanning resolution of reading can be configured to be the same as the main scanning resolution of the document image regardless of whether or not skew of the document is likely to occur.

That is, more generally, in a case where the main scanning resolution is set to a predetermined resolution that is not the highest resolution of the plurality of resolutions that are settable and it is determined that document skew is likely to occur, the resolution of reading can be configured to be set to a resolution higher than the predetermined resolution.

In a case where the main scanning resolution of reading is set to be higher than the main scanning resolution of the document image, the sub-scanning resolution in document reading can also be set to be higher than the sub-scanning resolution of the document image. Note that even if the main scanning resolution of reading is set to be higher than the main scanning resolution of the document image, the sub-scanning resolution in document reading may be the same as the sub-scanning resolution of the document image.

Embodiment(s) of the present disclosure can also be realized by a computer of a system or apparatus that reads out and executes computer-executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2025-016996, which was filed on February 4, 2025 and which is hereby incorporated by reference herein in its entirety.

What is claimed is:

1. A document reading apparatus comprising:
a tray on which a document can be placed;
a conveyance unit configured to convey the document placed on the tray;
a reading unit configured to read the document being conveyed in a conveyance direction by the conveyance unit to output first image data;
an image processing unit configured to generate second image data from the first image data by image processing including correction processing of correcting the first image data based on correction data;
a reference member; and
at least one processor, wherein the at least one processor is configured to:
set a reading operation parameter including a resolution parameter indicating a resolution in the conveyance direction and a resolution in a width direction orthogonal to the conveyance direction of an image indicated by the second image data,
perform generation processing of generating the correction data by causing the reading unit to read the reference member, and
control whether to set the resolution in the width direction when causing the reading unit to read the reference member to a first resolution or a second resolution lower than the first resolution based on one or more parameters regarding a size of a document included in the reading operation parameter in a case where the resolution parameter when performing the generation processing indicates the second resolution as the resolution in the width direction.

2. The document reading apparatus according to claim 1, wherein the one or more parameters are parameters set to any of a plurality of setting values including a first setting value and a second setting value, with which skew of the document is more likely to occur than with the first setting value.

3. The document reading apparatus according to claim 2, wherein the at least one processor is further configured to set the resolution in the width direction when causing the reading unit to read the reference member to the first resolution in a case where the resolution parameter when performing the generation processing indicates the second resolution as the resolution in the width direction and at least one parameter of the one or more parameters is set to the second setting value.

4. The document reading apparatus according to claim 2, wherein the at least one processor is further configured to set the resolution in the width direction when causing the reading unit to read the reference member to the second resolution in a case where the resolution parameter when performing the generation processing indicates the second resolution as the resolution in the width direction and all of the one or more parameters are set to the first setting value.

5. The document reading apparatus according to claim 2, wherein the one or more parameters include a first parameter to be set to any of the first setting value indicating that a plurality of documents having a same length in the width direction are placed on the tray and the second setting value indicating that the plurality of documents having different lengths in the width direction are placed on the tray.

6. The document reading apparatus according to claim 2, wherein the one or more parameters include a second parameter to be set to any of the first setting value indicating that a size of the document is a standard size and the second setting value indicating that a size of the document is not a standard size.

7. The document reading apparatus according to claim 1, wherein the at least one processor is further configured to set the resolution in the width direction when causing the reading unit to read the reference member to the first resolution in a case where the resolution parameter when performing the generation processing indicates the first resolution as the resolution in the width direction.

8. The document reading apparatus according to claim 1, wherein the at least one processor is further configured to perform the generation processing that is next, after generating the correction data by the generation processing, in a case where a change in setting of the reading operation parameter by the setting unit causes the resolution in the width direction determined based on the reading operation parameter before the change to be different from the resolution in the width direction determined based on the reading operation parameter after the change.

9. The document reading apparatus according to claim 8, wherein
the reading operation parameter includes a color parameter indicating whether to cause the reading unit to output the first image data that is in color or to output the first image data that is in monochrome, and
the at least one processor is further configured to perform the generation processing that is next, after generating the correction data by the generation processing, when the setting unit changes the color parameter.

10. The document reading apparatus according to claim 1, wherein the at least one processor is further configured to stop the generation processing being executed and start the generation processing that is next based on the reading operation parameter after a change, in a case where the change in setting of the reading operation parameter by the setting unit while the generation processing is being executed causes the resolution in the width direction in the generation processing being executed to be different from the resolution in the width direction determined based on the reading operation parameter after the change.

11. The document reading apparatus according to claim 10, wherein
the reading operation parameter includes a color parameter indicating whether to cause the reading unit to output the first image data that is in color or to output the first image data that is in monochrome, and
the at least one processor is further configured to stop the generation processing being executed and start the generation processing that is next based on the reading operation parameter after a change, when the setting unit changes the color parameter while the generation processing is being executed.

12. The document reading apparatus according to claim 1, wherein the at least one processor is further configured to control whether to set the resolution in the width direction when causing the reading unit to read the document to the first resolution or the second resolution based on the one or more parameters, in a case where the reading operation parameter when an instruction for reading start is input indicates the second resolution as the resolution in the width direction.

13. The document reading apparatus according to claim 12, wherein the at least one processor is further configured to control the resolution in the conveyance direction when causing the reading unit to read the document to be a third resolution even if the reading operation parameter indicates a fourth resolution which is lower than the third resolution as the resolution in the conveyance direction in a case where the reading operation parameter when the instruction for reading start is input indicates the second resolution as the resolution in the width direction but the at least one processor controls the resolution in the width direction when causing the reading unit to read the document to the first resolution.

14. The document reading apparatus according to claim 12, wherein the image processing unit is further configured to perform resolution conversion processing on the first image data in the image processing so that the resolution in the width direction of the image indicated by the second image data becomes the second resolution in a case where the reading operation parameter when the instruction for reading start is input indicates the second resolution as the resolution in the width direction but the at least one processor controls the resolution in the width direction when causing the reading unit to read the document to the first resolution.

15. The document reading apparatus according to claim 12, wherein the conveyance unit is further configured to make a conveyance speed of the document, in a case where the resolution in the width direction when causing the reading unit to read the document is the first resolution, different from a conveyance speed of the document in a case where the resolution in the width direction when causing the reading unit to read the document is the second resolution.

16. The document reading apparatus according to claim 1, wherein the image processing includes processing of correcting skew of the document detected based on the first image data.

17. The document reading apparatus according to claim 1, wherein the correction processing is shading correction processing.

18. A document reading apparatus comprising:
a tray on which a document can be placed;
a conveyance unit configured to convey the document placed on the tray;
a reading unit configured to read the document being conveyed in a conveyance direction by the conveyance unit to output first image data;
an image processing unit configured to generate second image data from the first image data by image processing including correction processing of correcting the first image data based on correction data;
a reference member; and
at least one processor, wherein the at least one processor is configured to:
set a reading operation parameter including a resolution parameter indicating a resolution in the conveyance direction and a resolution in a width direction orthogonal to the conveyance direction of an image indicated by the second image data,
perform generation processing of generating the correction data by causing the reading unit to read the reference member, and
control whether or not to execute the generation processing based on the resolution in the width direction and one or more parameters regarding a size of a document included in the reading operation parameter when a setting of the reading operation parameter is changed.

19. The document reading apparatus according to claim 18, wherein the one or more parameters are parameters set to any of a plurality of setting values including a first setting value and a second setting value, with which skew of the document is more likely to occur than with the first setting value.

20. The document reading apparatus according to claim 19, wherein the one or more parameters include a first parameter to be set to any of the first setting value indicating that a plurality of documents having a same length in the width direction are placed on the tray and the second setting value indicating that the plurality of documents having different lengths in the width direction are placed on the tray.

21. The document reading apparatus according to claim 19, wherein the one or more parameters include a second parameter to be set to any of the first setting value indicating that a size of the document is a standard size and the second setting value indicating that a size of the document is not a standard size.

22. The document reading apparatus according to claim 19, wherein the at least one processor is further configured to execute the generation processing when a state in which at least one parameter of the one or more parameters is set to the second setting value is changed to a state in which all of the one or more parameters are set to the first setting value, in a case where the resolution parameter indicates a second resolution lower than a first resolution as the resolution in the width direction.

23. The document reading apparatus according to claim 19, wherein the at least one processor is further configured to execute the generation processing when a state in which all of the one or more parameters are set to the first setting value is changed to a state in which at least one parameter of the one or more parameters is set to the second setting value, in a case where the resolution parameter indicates a second resolution lower than a first resolution as the resolution in the width direction.

24. The document reading apparatus according to claim 19, wherein the at least one processor is further configured to not execute the generation processing even if a state in which at least one parameter of the one or more parameters is set to the second setting value is changed to a state in which at least one parameter of the one or more parameters is set to the second setting value, in a case where the resolution parameter indicates a second resolution lower than a first resolution as the resolution in the width direction.

25. The document reading apparatus according to claim 19, wherein the at least one processor is further configured to not execute the generation processing even if the one or more parameters are changed, in a case where the resolution parameter indicates a first resolution higher than a second resolution as the resolution in the width direction.

26. The document reading apparatus according to claim 19, wherein the at least one processor is further configured to execute the generation processing when the resolution in the width direction is changed, in a case where all of the one or more parameters are set to the first setting value.

27. The document reading apparatus according to claim 19, wherein the at least one processor is configured to not execute the generation processing even when the resolution in the width direction is changed, in a case where at least one parameter of the one or more parameters is set to the second setting value.

28. The document reading apparatus according to claim 18, wherein
the one or more parameters include a color parameter indicating whether to cause the reading unit to output the first image data that is in color or to output the first image data that is in monochrome, and
the at least one processor is configured to execute the generation processing when the color parameter is changed.
